(19) United States
(12) Patent Application Publication
(10) Pub. No.: US 2022/0385052 A1
(43) Pub. Date: Dec. 1, 2022

(54) QUICK RELEASE ELECTRICAL BOX ELECTRICAL CABLE CLAMPING SYSTEM

(71) Applicant: Thomas Ellis Stanley Haskins, Holbrook, MA (US)

(72) Inventor: Thomas Ellis Stanley Haskins, Holbrook, MA (US)

(21) Appl. No.: 17/200,806

(22) Filed: Mar. 13, 2021

(51) Int. Cl. H02G 3/08

(52) U.S. Cl. CPC H02G 3/083

(57) ABSTRACT

The unique aspect of this invention is the fact that currently designed (not yet manufactured), newly and not yet manufactured or yet to be designed quick install electrical cable clamps, while currently very difficult to release for repositioning the electrical cable, while requiring the user to risk damaging the electrical cable insulation and the cable itself when attempting to release the 10 cable clamp, will with this invention be able to be easily held in a released position while at the same time the user is repositioning or removing the electrical cable.

### BACKGROUND OF THE INVENTION

### 1. Field of the Invention

The present invention generally relates to an electrical cable damp that is either built into an electrical box or can be easily installed to an electrical box and is different from current such products on the market as follows:

1. A quick release tab that is added to the existing design of quick-install electrical box (such as electrical gang boxes and circuit breaker boxes), cable clamps such that with the use of the finger or other tool the user can pry open the cable damp jaws enabling the user to easily reposition or remove the cable.

2. A quick release cable damping arm that is designed into the structure and manufacture of existing or new electrical gang box designs at the point where the electrical cable is installed into the gang box, such that with the use of the finger or other tool, the user can push the cable clamping arm into and against the electrical cable, damping down on it to hold it firmly into position and later easily pry back the cable clamping arm to release the cable from its hold, enabling the user to easily reposition or remove the cable. This unique feature enables the user to both damp the cable and release the cable from the clamping mechanism without danger of touching or damaging the cable.

3. A quick release cable damping arm, damping screw and damping screw support arm that are designed into the structure and manufacture of existing or new electrical gang box designs at the point where the electrical cable is installed into the gang box, such that with the use of a screw driver or other tool, the user can screw or unscrew the damping screw through the damping screw support arm thus pushing the cable damping arm into and against the electrical cable, damping down on it to hold it firmly into position and unscrewing the damping screw through the damping screw support arm thus releasing the cable damping arm from its pressure on the cable, enabling the user to easily reposition or remove the cable. This unique feature enables the user to both clamp the cable and release the cable from the clamping mechanism without danger of touching or damaging the cable. This feature is unique from current product designs that include a clamping screw in three ways:
a. It has a clamping arm that pivots where it is connected to the inside surface of the electrical gang box and the clamping screw only pushes only one end of the clamping arm into the electrical cable while the other end remains unmoved pivots and is attached to the gang box.
b. unlike other damping arms with clamping screws this design holds the electrical cable in place with one pointed end of the arm rather than having the entire arm move up and down on the screw.

### 2. Description of Related Art

Current products and technology on the market:
a. Current similar products on the market vary widely. Some are insertable into an electrical box and some are built into the gang box. None currently have a quick release tab mechanism or anything comparable such as is found in this application. They all have the following negative features:
   I. Once the cable is installed into and through the cable clamp it is very difficult to release the clamping jaws so that the cable can be repositioned or removed easily
   II. Once the cable is installed into and through the cable clamp any attempt to release the clamping jaws to reposition or remove the electrical cable will be accompanied by a high likelihood of touching and damaging the cable as you try to pry open the clamping jaws.

### SUMMARY OF THE INVENTION

This product is similar to existing products on the market with two major differences:

1. Modifies the design and structure of current products and allows for the design of new products such that each quick-install electrical box cable clamp has a quick release feature such as an additional and very accessible tab attached to the clamping jaws that makes it easy to release the pressure of the clamping jaws on the electrical cable in order to reposition or remove the cable. 2. Modifies the design and structure of current products and allows for the design of new products such that a specially-designed cable clamping arm is added to the body of the gang box that has a variety of unique features and benefits to its design.

### DETAILED DESCIPTION OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout. Unless otherwise noted in this specification or in the claims, all of the terms used in the specification and the claims will have the meanings normally ascribed to these terms by workers in the art.
This product is similar to existing products on the market with two major differences:

1. Modifies the design and structure of current products and allows for the design of new products such that each quick-install electrical box cable clamp has a quick release feature such as an additional and very accessible tab that is attached to the clamping jaws

2. Modifies the design and structure of current products and allows for the design of new products such that a specially-designed cable clamping arm is added to the body of the gang box that has the following features:
a. May be pushed down and against the cable using a finger or other tool pushing downward on the top and end of the clamping arm in the direction of the cable to clamp the cable in place
b. May be pushed back and pulled up from its clamping arm stop, perpendicular to the cable and raised away from the cable to release the cable from the clamping arm's clamping point, releasing the cable to be repositioned or removed.
c. Has a clamping arm stop that holds the clamping arm in place where the user places it by pushing downward on the arm adjusting tab. This stop holds the clamping arm in place by way of stepped position control teeth in the clamping arm facing the clamping arm stop
d. Has stepped position control teeth built into the clamping arm and facing the clamping arm stop, which are pressed against the clamping arm stop by way of the spring nature of the clamping arm. These stepped position control teeth are released from holding contact with the clamping arm stop when the user presses back and pulls up against the release tab on the top of the clamping arm, pulling the arm and stepped position control teeth away from the clamping arm stop
e. Is attached to the side of the gang box above the access point opening in the gang box through which the cable is installed to so the gang box.
f. A release tab located at the top and end of the clamping arm used to pull or press back against the clamping arm and pulled up and away from the cable to release the stepped position control teeth from the clamping arm stop

3. Modifies the design and structure of current products and allows for the design of new products such that an easily controlled pivoting cable clamping arm is minutely controlled by a clamping screw.

### BENEFITS OF THESE INNOVATIONS:

1. Quick and easy access to release the damping jaws in order to reposition or remove the electrical cable

2. Reduced risk of the following while repositioning or removing the electrical cable once installed:
1. Damage to the cable insulation and/or wire inside the insulation
2. Damage to the clamping jaws and just providing less dependable clamping action on the electrical cable
3. Electrical chock to user while trying to reposition or remove the electrical cable while still energized
4. Fire resulting from a damage electrical cable

3. Greater control over the cable clamping mechanism

### DESCRIPTION OF DRAWINGS

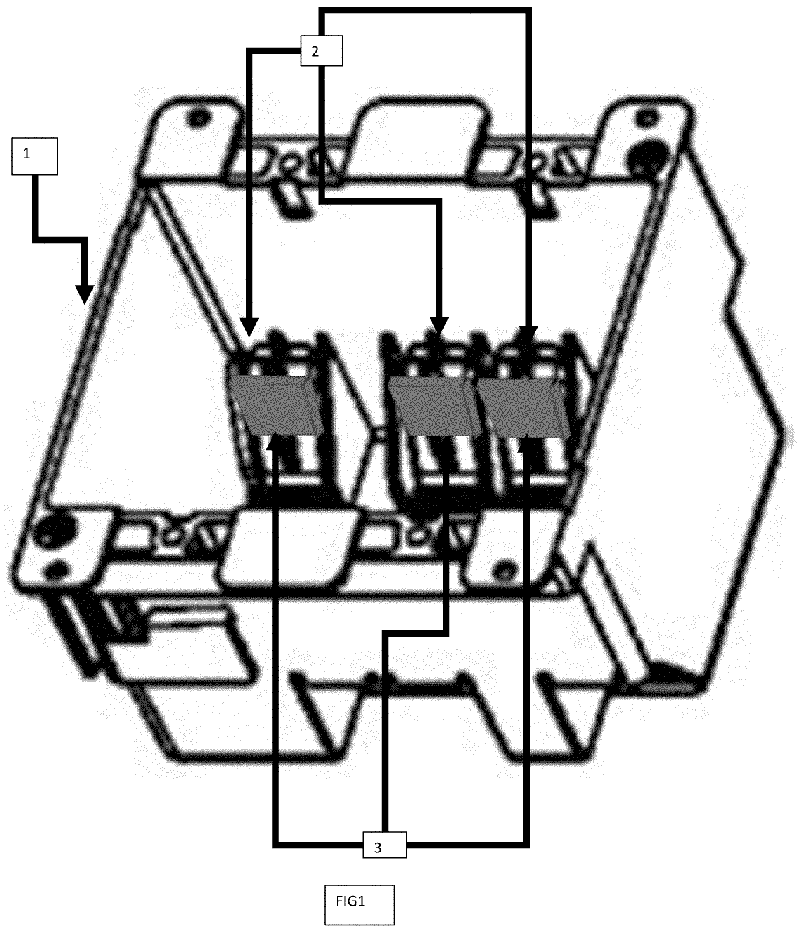

1. FIG. 1 illustrates a schematic of an existing design electrical gang box 1 highlighting one kind of design and how this innovation would improve it by highlighting the following:
1. An existing design electrical gang box 1
2. A plurality of quick-install electrical cable installation ports with clamps currently found in existing electrical gang box designs
3. A plurality of quick release tabs added to existing and future electrical cable clamp designs enabling the user to hold the clamp open with a finger or other instrument while repositioning or removing the electrical cable.

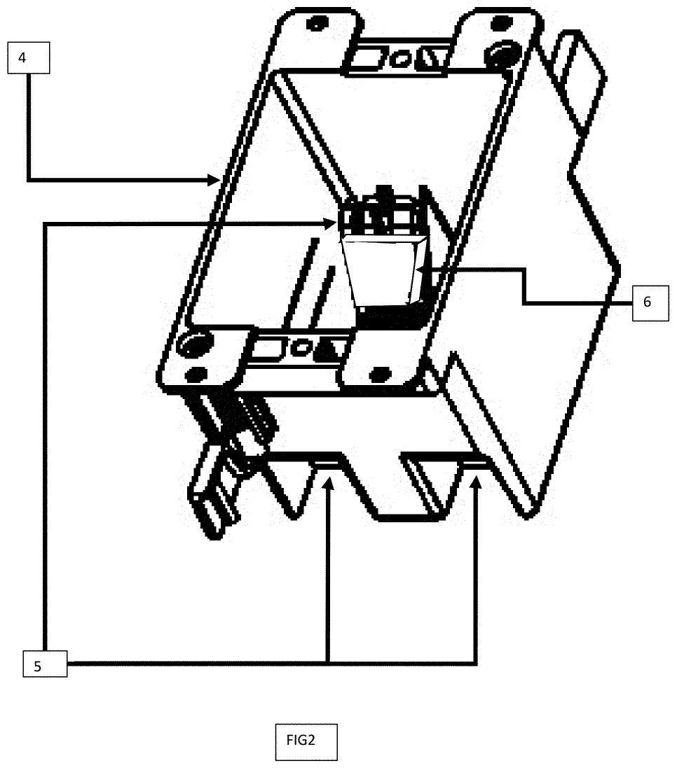

2. FIG. 2 illustrates a schematic 3 dimensional view of a 1-gang electrical box highlighting another kind of existing design and how this innovation would improve it:
4. An existing design electrical gang box
5. A plurality of quick-install electrical cable installation ports with clamps currently found in existing electrical gang box designs
6. A plurality of quick release tabs added to the electrical cable clamps on existing design of products enabling the user to hold the clamp open with a finger or other instrument while repositioning or removing the electrical cable.

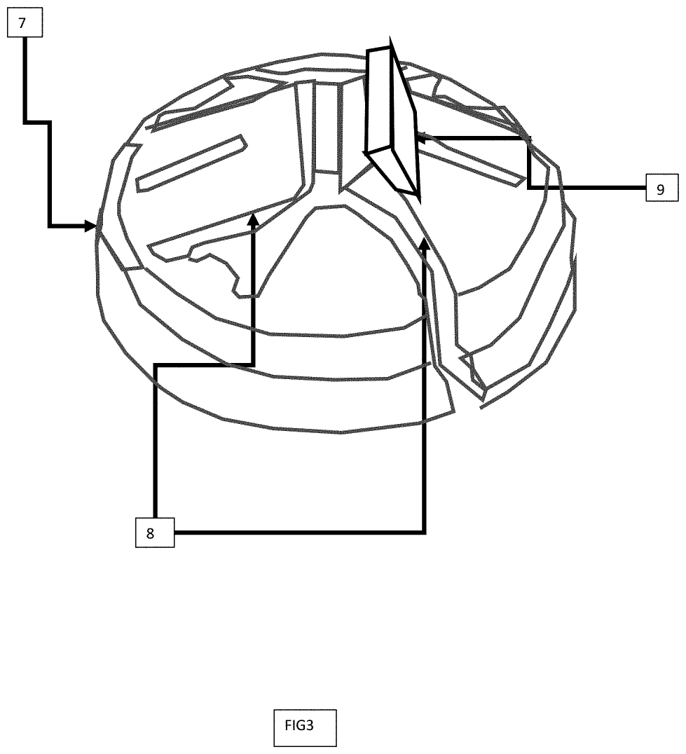

FIG. 3 illustrates a schematic 3 dimensional view of an existing design for a 3 jaw quick install cable clamp that can be quickly installed into some existing electrical box which allows user to quick-install electrical cables into the gang box and how this innovation would improve it:
7. An quick-install electrical cable clamp currently found currently found on the market
8. Cable clamp jaws
9. A quick release tab added to the electrical cable clamp jaws on existing design of products enabling the user to hold the clamp open with a finger or other instrument while repositioning or removing the electrical cable.

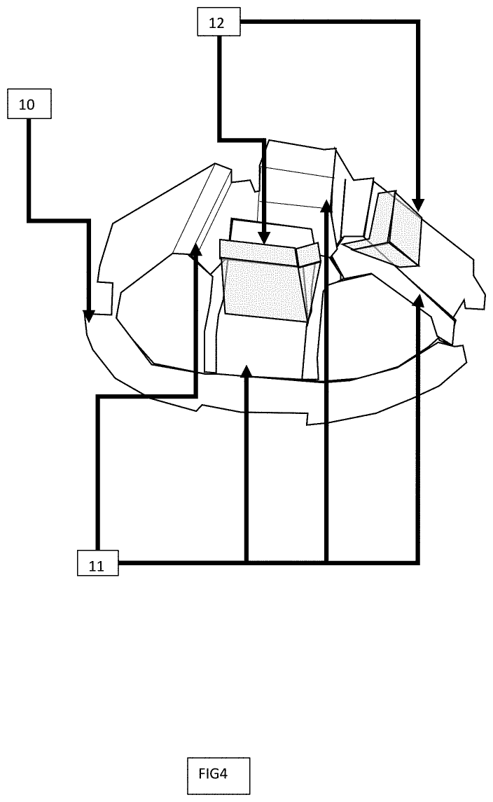

FIG. 4 illustrates a schematic 3 dimensional view of an existing design for a 4 jaw quick install cable clamp that can be quickly installed into some existing electrical box designs which allows user to quick-install electrical cables into the box and how this innovation would improve it:
10. A quick-install electrical cable clamp currently found currently found on the market
11. Cable clamp jaws
12. A quick release tab added to the electrical cable clamp jaws on existing design of products enabling the user to hold the clamp open with a finger or other instrument while repositioning or removing the electrical cable.

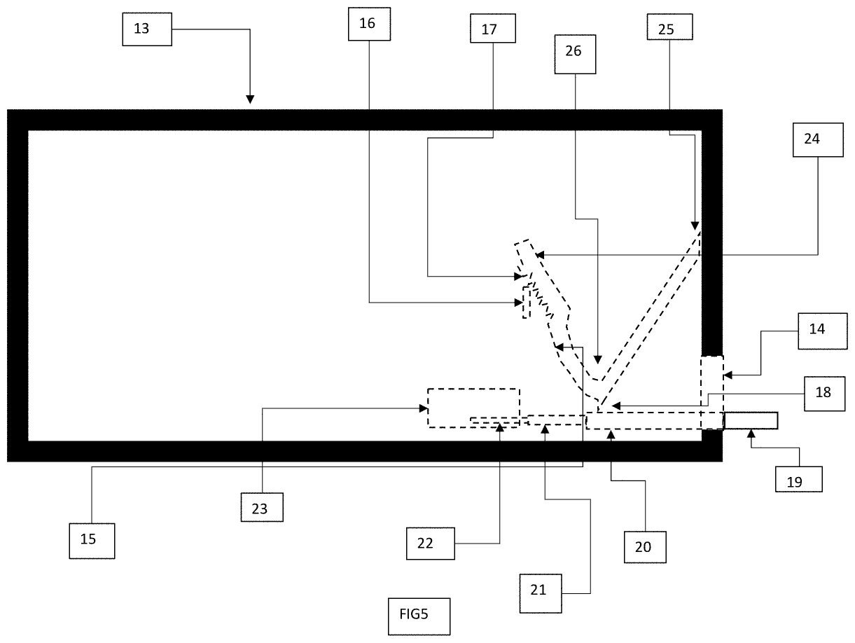

FIG. 5 illustrates a schematic of an existing single gang electrical gang box with quick install clamps built into it and how this innovation would improve it:
13. An existing design electrical gang box
14. A plurality of electrical cable installation ports currently found in existing electrical gang box designs (only one shown in this illustration, however this design allows for a plurality)
15. A plurality of cable clamping arms that clamp down and hold electrical cable in place
16. A plurality of adjustment stops to hold clamping arm in position chosen by user via the Stepped position control teeth
17. A plurality of Stepped position control teeth that are pressed against a plurality of adjustment stops by the spring action of a plurality of cable clamping arm
18. A plurality of cable clamping point to hold electrical cable in place
19. A plurality of electrical cables
20. Illustration of location of a plurality of electrical cable inside the gang box w/outer insulation still on it
21. Illustration of location of a plurality of electrical cable w/inner insulation still on it
22. Illustration of location of a plurality of electrical wire with no insulation
23. A wire connection/clamp
24. A cable clamping arm adjustment tab
25. A cable clamp pivot point
26. A cable clamp flex point

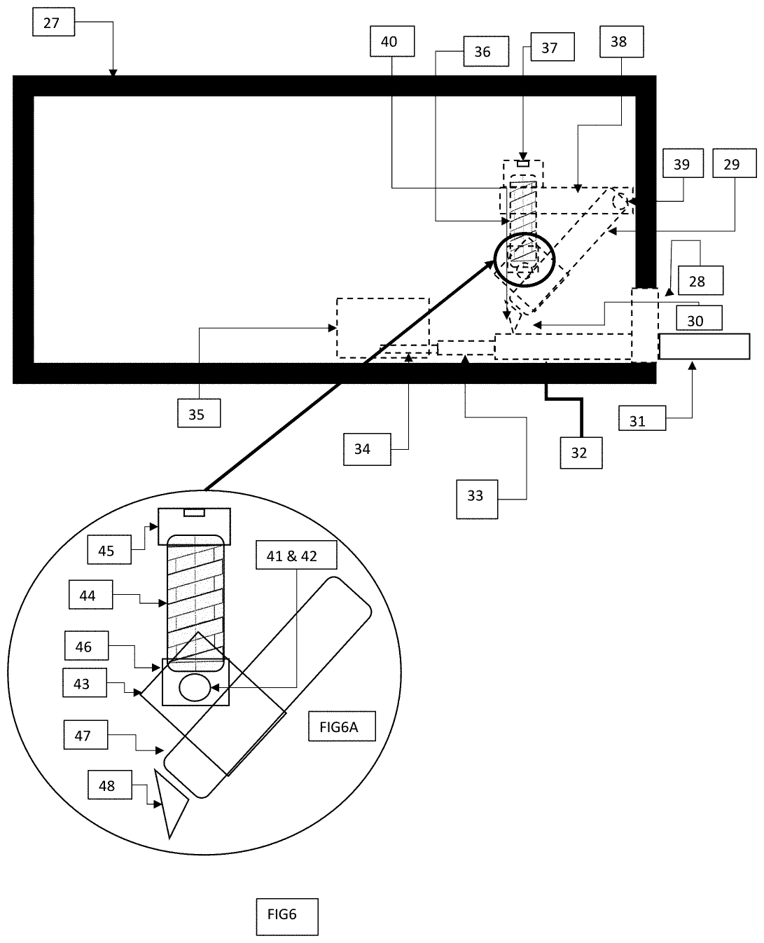

FIG. 6 illustrates a schematic of and existing single gang electrical gang box with this innovation of a pivoting clamping arm attached to the inside surface of the gang box that is activated and controlled by a clamping screw which moves only the pointed end of the clamping arm against the electrical cable. The clamping screw operates in the clamping screw support arm and the clamping screw spinning end nut. It has the following features:
27. An existing design electrical gang box
28. An electrical cable installation port currently found in existing electrical gang box designs (only one shown in this illustration, however this design allows for a plurality)
29. Cable clamping arms that press the cable clamping point against electrical cable thus clamping it in place
30. A cable clamping point to hold electrical cable in place
31. Electrical cables
32. Illustration of location of the electrical cable inside the gang box w/outer insulation still on it
33. Illustration of location of the electrical cable w/inner insulation still on it
34. Illustration of location of the electrical wire with no insulation
35. A wire connection/clamp
36. A clamping screw
37. A lamping screw head
38. A clamping screw support arm
39. A clamping arm pivot bold and matching hole
40. A clamping arm cable clamping point

FIG. 6A A clamping screw spinning end nut attached to a clamping screw and having a pin hole and a matching a clamping screw spinning end nut pin
41. A clamping screw spinning end nut pin hole receives the clamping screw end nut holding pin
42. A clamping screw spinning end nut holding pin that connects the damping screw end nut to the clamping screw while still allowing the damping screw to turn
43. A damping screw/clamping arm sliding connection bracket wraps around the clamping arm and is attached to the damping screw spinning end nut such that it can slide up and down the damping arm while the clamping screw is turned
44. Clamping screw
45. Clamping screw head
46. Clamping screw spinning end nut
47. Clamping arm cable clamping point
   These and other changes can be made to the invention in light of the above detailed description. In general, the terms used in the following claims, should not be construed to limit the invention to the specific embodiments disclosed in the specification, unless the above detailed description explicitly defines 15 such terms. Accordingly, the actual scope of the invention encompasses the disclosed embodiments and all equivalent ways of practicing or implementing the invention under the claims.

1. A plurality of uniquely designed electrical box electrical cable clamp release tabs made of a variety of materials
Attached to existing or newly designed and no yet manufactured manufacture quick release electrical box cable clamps:
A plurality of rigid tabs; and
Placed on existing or newly designed cable clamp jaws to provide easy access to tab by finger or other tool; and
Placed at an angle to existing or newly designed cable clamp jaws to provide leverage using finger or other tool to pry open cable clamp jaws; and
Large enough to allow proper grip by finger or other tool to apply pressure that will open cable clamp jaws and release electrical cable to be repositioned or removed easily; and
a variety of sizes and shapes.

2. A plurality of uniquely designed electrical gang box electrical cable clamping arms
Attached to existing or newly designed and no yet manufactured electrical gang boxes:
A plurality of cable clamping arms that are attached to the inside wall of an electrical gang box just above a plurality of electrical cable installation ports; and
A plurality of cable clamping arms that pivot on a plurality of points at which they are attached to the gang box
A plurality of cable clamping arms with a bend in the arms, or a flex points that create a spring action in the arms pressing the end of the arms with there a plurality of stepped position control teeth against a plurality of adjustment stops; and
A plurality of adjustment stops that hold a plurality of cable clamping arms in place as a plurality of stepped position control teeth are pressed against them by the spring action of the bend in the cable damping arm
A plurality of stepped position control teeth in a plurality of arms near the end of a plurality of arms and facing a plurality of adjustment stops, that are pressed against a plurality of adjustment stops by the spring action in a plurality of cable clamping arms to hold the a plurality of clamping arms in position as placed by the user; and
A plurality of cable clamping points in a plurality of cables clamping arms, sharp enough to hold a plurality of cables in place as a plurality of cable clamping arms are pressed against the outer insulation of a plurality of cables and not sharp enough to damage the outer insulation of the cables; and
A plurality of adjustment tabs located at the end and top of a plurality of cable clamping arm which user utilizes to press into place and/or release a plurality of cable clamping arms.

3. A plurality of uniquely designed electrical gang box electrical cable clamping arms with clamping screws
Attached to existing or newly designed and no yet manufactured electrical gang boxes:
A plurality of electrical cable clamping arms with a variety of possible shapes and sizes and attached to the inside surface of an electrical gang box just above a plurality of electrical cable installation ports; and
A plurality of electrical cable damping arms that pivot at the point where they are attached to the inside surface of the gang box; and
A plurality of damping screws that can be screwed downward toward a plurality of cable clamping arms pressing them against a plurality of electrical cables clamping the cables in place and can be unscrewed to release a plurality of clamping arms; and
A plurality of clamping screw support arms with a plurality of threaded holes through which a plurality of clamping screws travel as they are screwed in/down or out/up; and
A plurality of cable clamping points at the end of a plurality of cable clamping arms, sharp enough to hold a plurality of electrical cables in place but not sharp enough to damage the outer insulation of the cables; and
A plurality of clamping screw spinning end nuts attached to a plurality of clamping screws having a plurality of pin holes matching a plurality of clamping screw spinning end nut pins
A plurality of clamping screw spinning end nut pin holes
A plurality of clamping screw spinning end nut pins
A plurality of clamping screw/clamping arm sliding connection brackets
A plurality of pivoting mechanisms designed into a plurality of cable clamping arms including the following options:
(1) A plurality of pivot bolts and matching pivot holes placed in a plurality of clamping screw support arms where they attach to the gang box; and
(2) A plurality of attachment points where a plurality of clamping arms are attached to the gang box wherein
